(19) United States
(12) Patent Application Publication
(10) Pub. No.: US 2026/0186143 A1
(43) Pub. Date: Jul. 2, 2026

(54) SYSTEMS AND METHODS FOR CALIBRATION AND TRAJECTORY ENHANCEMENT OF LIDAR TECHNOLOGIES

(71) Applicant: Purdue Research Foundation, West Lafayette, IN (US)

(72) Inventors: Ayman Habib, West Lafayette, IN (US); Songlin Fei, West Lafayette, IN (US)

(21) Appl. No.: 19/130,400

(22) PCT Filed: Nov. 15, 2023
(86) PCT No.: PCT/US2023/079906

§ 371 Date: May 15, 2025

Related U.S. Application Data
(60) Provisional application No. 63/425,570, filed on Nov. 15, 2022.

(51) Int. Cl. G01S 17/89; G01S 7/481; G01S 17/86

(52) U.S. Cl. CPC G01S 17/89; G01S 7/4813; G01S 17/86

(57) ABSTRACT

Systems and methods for performing accurate, high-resolution forest inventories within a forest environment. The systems and methods preferably make use of an unmanned aerial vehicle and a ground-based carrier for acquiring first and second initial data frames that are obtained based on point cloud data scanned by a LIDAR mobile mapping system having substantially continuous accessibility to a Global Navigation Satellite System (GNSS) signal.

### BACKGROUND OF THE INVENTION

The disclosure generally relates to measurement tools and, more particularly, to LiDAR measurement tools.

Forest inventory has been relying on labor intensive manual measurements. Using remote sensing modalities for forest inventory has gained increasing attention in the last few decades. However, tools for deriving accurate tree level metrics are limited.

Forests provide critical ecosystem services (e.g., fiber and timber) but are constantly challenged by various environmental stressors. Data-driven policies and management practices, powered by accurate inventory, are essential for the long-term sustainability of forest ecosystems. Traditionally, forest inventory has been conducted manually, which is expensive and time-consuming. With recent advances in sensor and algorithmic technologies, remote/proximal sensing, including (a) LiDAR and photogrammetry from manned/unmanned aerial vehicles, (b) stationary terrestrial laser scanners (TLS), and (c) mobile ground LiDAR, has recently been explored as an alternative for automated tree-level inventory at various scales. These sensors/platforms have trade-offs in terms of cost, field survey efficiency, spatial coverage, spatial resolution, and level of detail of the acquired information.

Digital aerial photogrammetry using images acquired by manned aerial systems has attracted the attention of the forestry research community for estimating inventory attributes such as tree height, stem volume, and basal area. However, image-based point clouds mainly capture the outer envelope of a forest canopy. Manned airborne LiDAR provides large spatial coverage, fine resolution, and ability to represent the outer envelope and below-canopy structure. Upper and lower canopy mapping is facilitated by the fact that LiDAR energy can travel through gaps among the leaves and derive returns from tree trunks and terrain. Such ability makes LiDAR the most widely used technique for deriving ground slope and aspect, stem map, canopy height, crown dimension, and leaf area index (LAI). Compared to manned aerial systems, unmanned aerial vehicles (UAV) have a clear advantage in terms of their low cost, ease of deployment, rapid acquisition, ability to deliver fine resolution products, and higher frequency of field surveys. Several studies derived forest biometrics using orthophotos and point clouds generated from UAV images. UAV LiDAR matches most advantages of manned airborne LiDAR except for reduced spatial coverage. Several studies have applied UAV LiDAR data for segmenting individual trees and estimating canopy cover, tree height, diameter at breast height (DBH), and above-ground biomass. Nevertheless, with above-canopy flights, the ability of UAV LiDAR to map under-canopy features is limited by tree density and leaf cover. Detailed under-canopy mapping, which is necessary for deriving accurate estimates of critical forest biometrics like DBH and debris, is not always guaranteed.

Ground systems, including TLS and mobile ground LiDAR, can capture detailed below information. Prior research utilized high-quality data from TLS for deriving forest structural metrics at the stand-level. For TLS, large field surveys and data post are complex and time-consuming; thus, limited spatial coverage is the norm. Mobile ground systems can maneuver within the site to obtain large spatial coverage while mitigating occlusions. Several studies used ground systems for stem map generation, DBH estimation, and crown segmentation. However, point clouds from ground systems are prone to occlusions owing to terrain and above-ground objects. In addition, obstacles on the forest floor can restrict platform movement. The main challenge for under-canopy mobile LiDAR surveys is the intermittent access to the Global Navigation Satellite System (GNSS) signal, which is crucial to deriving accurately georeferenced mapping products from the onboard sensors.

Several studies tackled the mapping in GNSS-denied/challenging environments to derive high-quality LiDAR point clouds for forest inventory. Limitations of prior research include: (a) traditional approaches rely on acquired data by manned airborne systems, which are quite expensive and cannot be collected at a reasonable temporal resolution; (b) UAV based photogrammetric and LiDAR surveys, while being cost effective, cannot provide high resolution forest metrics at the single tree level; (c) static terrestrial LiDAR systems, while providing high resolution data, suffer from occlusions and require extensive fieldwork; (d) mobile ground LiDAR and photogrammetric systems suffer from GNSS signal outages, which impact the quality of derived products; and (e) the synergistic characteristics of UAV and mobile ground mapping systems are not fully explored. Research on improving the quality of mobile terrestrial remote sensing systems under GNSS signal outages is still lacking in terms of (a) partially refining positional or attitude information; (b) requiring extensive preprocessing for deriving suitable features for trajectory enhancement; (c) being incapable of handling different sensing modalities (e.g., images together with 2D and 3D LiDAR units); (d) not taking full advantage of onboard IMUs; (e) limiting the range of acquired data to few meters; (f) not providing georeferenced inventory metrics that could aid tracking of forest growth from temporal data acquisitions; and (g) being quite complex for scalable implementation.

### BRIEF SUMMARY OF THE INVENTION

The intent of this section of the specification is to briefly indicate the nature and substance of the invention, as opposed to an exhaustive statement of all subject matter and aspects of the invention. Therefore, while this section identifies subject matter recited in the claims, additional subject matter and aspects relating to the invention are set forth in other sections of the specification, particularly the detailed description, as well as any drawings.

The present invention provides, but is not limited to, systems and methods capable of performing accurate, high-resolution forest inventories within a forest environment.

According to a nonlimiting aspect of the invention, a LIDAR-based mapping method includes acquiring a first initial data frame and a second initial data frame, wherein the first initial data frame and the second initial data frame are obtained based on point cloud data scanned by a LIDAR mobile mapping system having substantially continuous accessibility to a Global Navigation Satellite System (GNSS) signal, extracting at least one of a planar feature and a cylindrical feature from the first initial data frame and at least one of a planar feature and a cylindrical feature from the second initial data frame according to a first predetermined algorithm, matching the at least one of a planar feature and a cylindrical feature from the first initial data frame and the at least one of a planar feature and a cylindrical feature from the second initial data frame according to a second predetermined algorithm, refining the matched at least one of a planar feature and a cylindrical feature from the first initial data frame and the at least one of a planar feature and a cylindrical feature from the second initial data frame by applying a non-linear least squares adjustment according to a third predetermined algorithm, and outputting the refined and matched at least one of a planar feature and a cylindrical feature from the first initial data frame and the at least one of a planar feature and a cylindrical feature from the second initial data frame into a combined frame.

According to another nonlimiting aspect of the invention, a system-driven framework is provided that is configured to perform a LIDAR-based mapping method as described above.

Other aspects and advantages will be appreciated from the following detailed description as well as any drawings.

### BRIEF DESCRIPTION OF THE SEVERAL VIEWS OF THE DRAWING

FIGS. 1A and 1B depict, respectively, an unmanned aerial vehicle (UAV) and a backpack (BP) equipped with mobile mapping systems and onboard sensors employed in investigations leading to the present invention.

FIG. 2 represents a study site containing twenty-two rows with fifty trees per row, and indicates trees removed and remaining after a thinning activity.

FIG. 3 is atop view showing flight trajectories for two UAV datasets overlaid on a point cloud.

FIGS. 4A and 4B are top views of a normalized height point cloud in a 1 to 3 meter range for two different UAV datasets.

FIGS. 5A and 5B depict a sample tree in two UAV datasets viewed from the X-Z plane (FIG. 5A) and the Y-Z plane (FIG. 5B).

FIG. 6 depicts original and lower quality trajectories for a BP dataset overlaid on a point cloud.

FIG. 7 depicts an elevational view showing a profile from a BP dataset generated from an original trajectory for qualitative evaluation of the level of misalignment.

FIG. 8 schematically represents a framework for system calibration and trajectory enhancement utilizing terrain patches and tree trunks.

FIG. 9 depicts planar features (terrain patches) extracted from a point cloud.

FIG. 10 depicts an elevational view showing minimum and maximum height thresholds used for tree trunk extraction and sample cylindrical features (tree trunks) extracted from a point cloud.

FIG. 11 schematically represents down sampled trajectory reference points used for trajectory enhancements.

FIGS. 12A and 12B depict geometric representations of planar features (FIG. 12A) and cylindrical features (FIG. 12B).

FIGS. 13A through 13D each depict a sample tree in original point clouds (left), point clouds after system calibration (center), and point clouds after conducting system calibration and trajectory enhancement (right). FIGS. 13A and 13B depict a first UAV dataset taken from views along, respectively, the X-Z and Y-Z planes, and FIGS. 13C and 13D depict a second UAV dataset taken from views along, respectively, the X-Z and Y-Z planes.

FIG. 14 depicts a sample tree from point clouds after sequential system calibration and trajectory enhancement for two UAV datasets along the X-Z and Y-Z planes.

FIGS. 15A through 15C depict elevational views showing a BP dataset after trajectory enhancement and evidencing the alignment quality for three different tests.

FIGS. 16A and 16B depict an enhanced trajectory for a BP dataset shaded by the magnitude of interpolated corrections for the position parameters overlaid on the study site's point cloud of a UAV dataset in two tests.

FIGS. 17A and 17B depict a sample tree in BP point clouds after trajectory enhancement and overlaid with the refined point cloud of a UAV dataset in two tests.

FIGS. 18 through 25 contain Tables 1 through 8, respectively.

### DETAILED DESCRIPTION OF THE INVENTION

The intended purpose of the following detailed description of the invention and the phraseology and terminology employed therein is to describe what is shown in the drawings, which include the depiction of and/or relate to one or more nonlimiting embodiments of the invention, and to describe certain but not all aspects of what is depicted in the drawings. The following detailed description also describes certain investigations relating to the embodiment(s) and identifies certain but not all alternatives of the embodiment(s). Therefore, the appended claims, and not the detailed description, are intended to particularly point out subject matter regarded to be aspects of the invention, including certain but not necessarily all of the aspects and alternatives described in the detailed description.

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. Regarding methods disclosed, the order of the steps presented is exemplary in nature, and thus, the order of the steps can be different in various embodiments, including where certain steps can be simultaneously performed. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

As referred to herein, disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping, or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, 3-9, and so on.

When an element or layer is referred to as being “on,” “engaged to,” “connected to,” or “coupled to” another element or layer, it may be directly on, engaged, connected, or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer, or section. Terms such as “first,” “second,” and other numerical terms when used herein do not imply a sequence or order unless clearly indicated by the context. Thus, a first element, component, region, layer, or section discussed below could be termed a second element, component, region, layer, or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figure is turned over, elements described as “below”, or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The present disclosure includes a system comprising a processor. The processor may be configured to perform various functions such as acquiring a first initial data frame and a second initial data frame, wherein the first initial data frame and the second initial data frame were obtained based on point cloud data scanned by a LIDAR mobile mapping system having substantially continuous accessibility to a Global Navigation Satellite System (GNSS) signal. The processer may also extract at least one of a planar feature and a cylindrical feature from the first initial data frame and at least one of a planar feature and a cylindrical feature from the second initial data frame according to a first predetermined algorithm. The processor may further match the at least one of a planar feature and a cylindrical feature from the first initial data frame and the at least one of a planar feature and a cylindrical feature from the second initial data frame according to a second predetermined algorithm. The processor may refine the matched at least one of a planar feature and a cylindrical feature from the first initial data frame and the at least one of a planar feature and a cylindrical feature from the second initial data frame by applying a non-linear least squares adjustment according to a third predetermined algorithm. The processor may also output the refined and matched at least one of a planar feature and a cylindrical feature from the first initial data frame and the at least one of a planar feature and a cylindrical feature from the second initial data frame into a combined frame.

The system may be used according to various methods. For instance, the system may be used according to a LIDAR-based mapping method. The method may include a step of acquiring a first initial data frame and a second initial data frame, wherein the first initial data frame and the second initial data frame were obtained based on point cloud data scanned by a LIDAR mobile mapping system having substantially continuous accessibility to a Global Navigation Satellite System (GNSS) signal. The method may further include extracting at least one of a planar feature and a cylindrical feature from the first initial data frame and at least one of a planar feature and a cylindrical feature from the second initial data frame according to a first predetermined algorithm. The method may also include matching the at least one of a planar feature and a cylindrical feature from the first initial data frame and the at least one of a planar feature and a cylindrical feature from the second initial data frame according to a second predetermined algorithm. The method may then include refining the matched at least one of a planar feature and a cylindrical feature from the first initial data frame and the at least one of a planar feature and a cylindrical feature from the second initial data frame by applying a non-linear least squares adjustment according to a third predetermined algorithm. The method may also include outputting the refined and matched at least one of a planar feature and a cylindrical feature from the first initial data frame and the at least one of a planar feature and a cylindrical feature from the second initial data frame into a combined frame.

Example embodiments are provided so that this disclosure will be thorough and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions, and methods can be made within the scope of the present technology, with substantially similar results.

In response to limitations of state of the art techniques for accurate forest stem mapping, the following describes a system-driven framework capable of conducting system calibration and trajectory enhancement for LiDAR units mounted on unmanned aerial vehicle (UAV) and backpack (BP) mobile mapping systems (MMS) to generate accurate point clouds for forest inventory. Features including tree trunks and terrain patches were extracted from the LiDAR point clouds. By minimizing discrepancies among features captured from different timestamps/tracks and different systems while considering both absolute and relative positional/rotational information provided by a GNSS/INS (Global Navigation Satellite System/Inertial Navigation System) based trajectory, system calibration and trajectory information were refined through a nonlinear LSA process. Notable contributions resulting from the investigations include the following:
A general, system-driven framework capable of conducting system calibration and trajectory enhancement for LiDAR MMS in forest environments;
In situ system calibration and trajectory enhancement for UAV datasets under leaf conditions to derive point clouds with high relative and absolute accuracy;
Performance of a proposed trajectory enhancement strategy for a backpack (BP) dataset under leaf on condition using trajectories with different quality and validation that a UAV dataset can be used as a reference to improve the relative/absolute quality of BP point clouds.

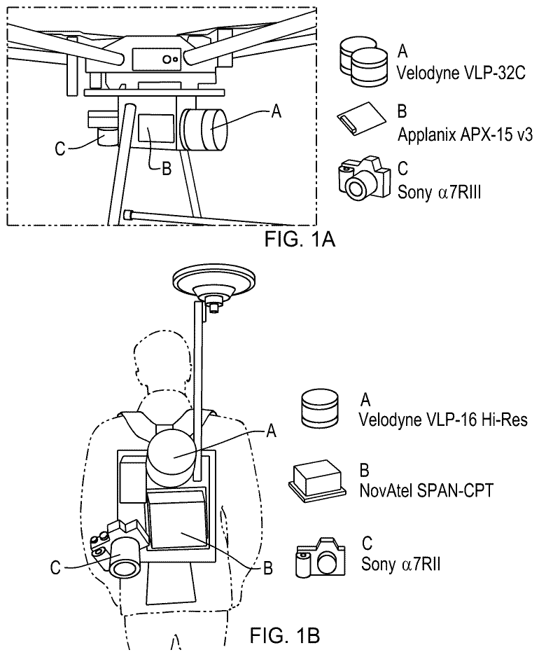

In the investigations, two UAV MMS systems were used, denoted as UAV-1 and UAV-2. The UAV-1 system (FIG. 1A) included a Velodyne VLP 32C LiDAR and a Sony α7R III camera. The payload of the UAV-2 system was the same as UAV-1 except for its camera, which was a Sony α7R camera. The rotation axes of the LiDAR units on both UAV systems were set to be approximately parallel to the flying direction of the UAVs. To promote the accuracy of the point cloud, a point was reconstructed only when the laser beam pointing direction was less than ±70° from the nadir. For both systems, the LiDAR data was directly georeferenced through an Applanix APX15 v3 GNSS/INS unit. The APX IMU data rate was 200 Hz. The Applanix APX15v3 GNSS/INS provided a post processing accuracy of 2-5 cm for position, 0.025° for roll/pitch angles, and 0.080° for heading angle. The backpack (BP) MMS (FIG. 1B) included a Velodyne VLP 16 Hi Res LiDAR and a Sony α7R II camera. A Novatel SPAN CPT GNSS/INS was used for direct georeferencing of the LiDAR. The SPAN CPT IMU data rate was 100 Hz. The Novatel SPAN CPT GNSS/INS provided a post processing accuracy of 1-2 cm for position, 0.008° for roll/pitch angles, and 0.026° for heading angle. Though a backpack was used for the BP MMS system, it is foreseeable that various other ground-based carriers—human and/or machine—could be utilized by which the MMS could be carried under a canopy.

To reconstruct accurate point clouds from MMS, rigorous system calibration was required to estimate the mounting parameters (lever arm and boresight angles) relating onboard LiDAR sensors to the GNSS/INS unit. In the investigations, the UAV and BP MMSs had undergone a feature-based system calibration. The expected accuracy of the point cloud following the system calibration was estimated based on the individual sensor specifications using a LiDAR Error Propagation Calculator; for a UAV MMS flying at a height of 50 m, the calculator suggested horizontal and vertical accuracy values in the ±5-6 cm range at the nadir position. At the edge of the swath, the horizontal accuracy would be about ±8-9 cm and the vertical accuracy would still be in the ±5-6 cm range. For the BP MMS system, the calculator suggested an accuracy of ±3 cm at a range of 50 m.

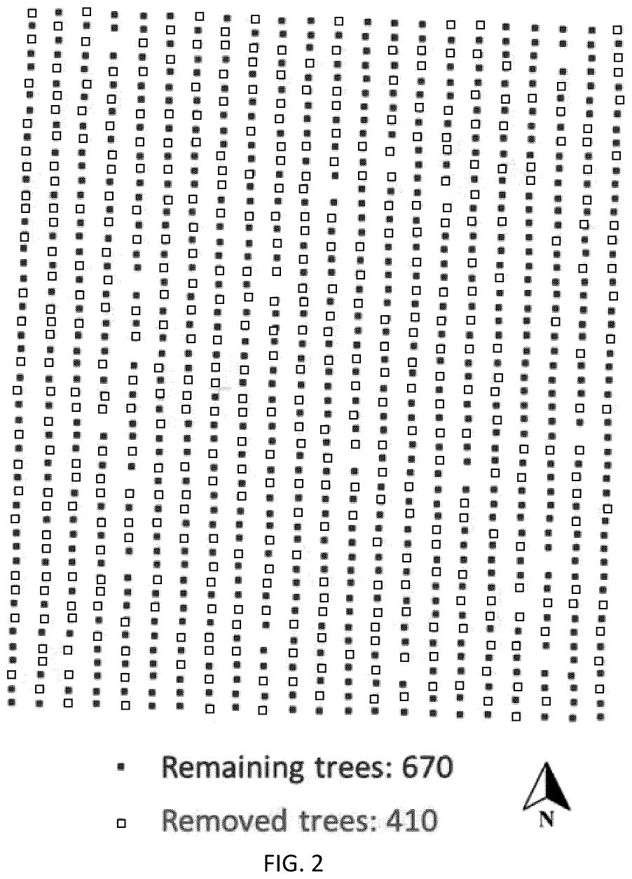

The study site used for the investigations was a forest plantation (FIG. 2) located at Martell Forest, a research forest owned and managed by Purdue University, in West Lafayette, IN, USA. The site was planted in 2007 with northern red oak (Quercus rubra) as the primary species and burr oak (Q. macrocarpa) as trainers. The plot follows a grid pattern of twenty-two rows and fifty trees per row. Between row spacing was approximately 5 m and between tree spacing within a row was approximately 2.5 m. Tree height in the study area ranges from 10 to 13 m at measurement year 13 with an average diameter at breast height (DBH) of 12.7 cm. Within each row, the branches of neighboring trees interlaced with each other. The understory vegetation within the plot, including voluntary seedlings and herbaceous species, had been removed on an annual basis. In 2021, there was a total of 1080 trees in Plot 115. The plot has gone through a tree thinning activity in late February 2022, and 410 trees were cut down, as shown in FIG. 2.

Three datasets were collected during the investigations over Plot 115 on different dates: (a) LiDAR data collected by the UAV-1 system on Mar. 13, 2021 (denoted herein as UAV-2021 dataset) under leaf off condition, (b) LiDAR data collected by the UAV-2 system on Mar. 3, 2022 (denoted herein as UAV-2022 dataset) under leaf off condition, and (c) LiDAR data collected by the BP system on Aug. 5, 2021 (denoted herein as BP-2021 dataset) under leaf on condition. The UAV-2021 and BP-2021 datasets were acquired before the tree thinning activity while the UAV-2022 dataset was acquired afterward. Detailed information and characteristics of these datasets are discussed below.

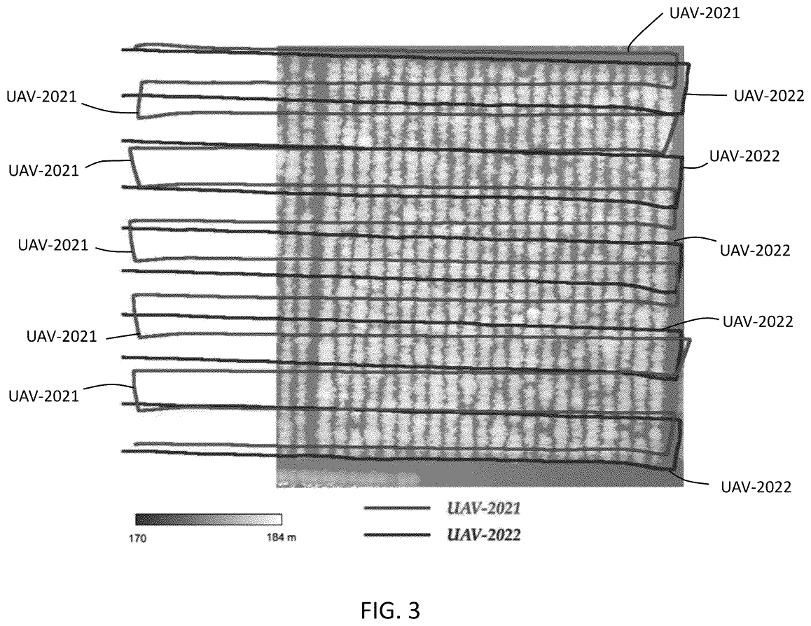

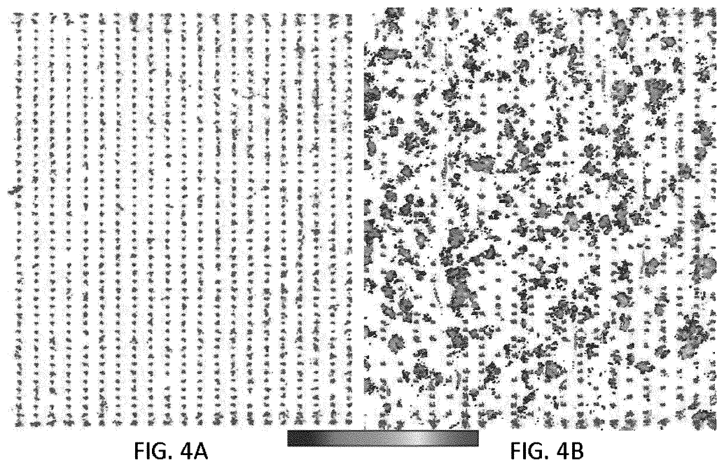

Given that tree trunks might not be captured by UAV LiDAR systems during leaf on conditions, both UAV datasets were collected under lead off conditions as the proposed framework was based on the availability of tree trunk features. For the UAV-2021 dataset, UAV-1 was flown at 40 m above ground with a speed of 3.5 m/s. The flight mission included twelve east-west flight lines and the lateral distance between adjacent flight lines was 11 m. The side lap percentage of the point cloud was 95% while considering ±70° off-nadir reconstruction. The flight configuration for the UAV-2022 dataset was the same as the UAV-2021 dataset except that the number of flight lines was ten and the lateral distance between adjacent flight lines was 13 m. This led to a side lap percentage of about 80%. FIG. 3 shows a top view of the flight trajectory for the two UAV datasets. The UAV systems were flown above the canopy under an open sky without GNSS signal outages; thus, the post processed trajectory was expected to be accurate. As mentioned above, the UAV-2022 dataset was captured after a tree thinning activity. During this management practice, a large amount of tree debris was left at the study site. FIGS. 4A and 4B present the reconstructed point clouds after height normalization relative to the ground level in the 1-3 m range for the UAV-2021 and UAV-2022 datasets, respectively. It can be seen from FIGS. 4A and 4B that the UAV-2021 dataset had a very clear definition of tree trunks while debris in the UAV-2022 dataset was visible, thus leading to expected difficulty in extracting tree trunks and terrain patches, which will be used for the following system calibration and trajectory enhancement.

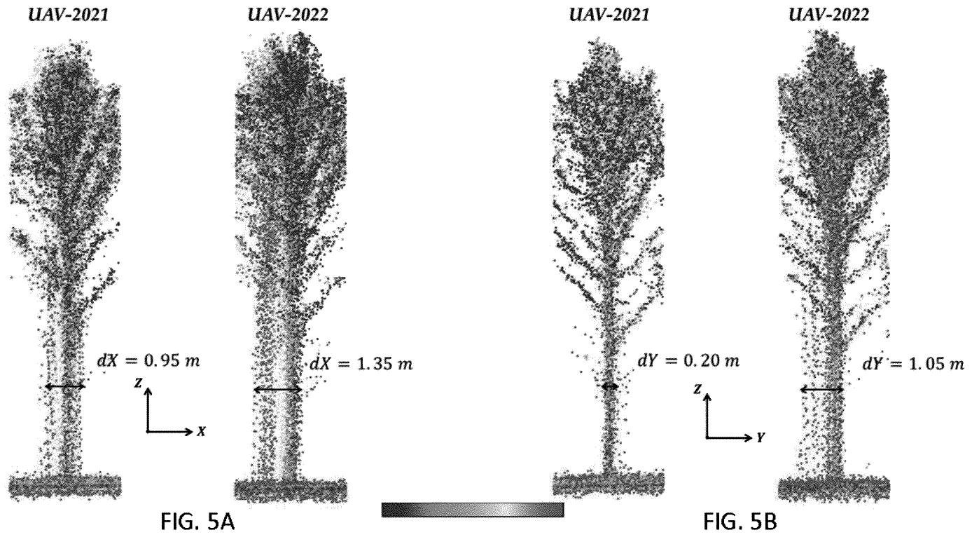

FIGS. 5A and 5B depict a sample tree from the two UAV datasets where LiDAR points with large range measurements came from flight lines with large planimetric distances to the tree. For the UAV-2021 point cloud, the noise level in the X direction (flight direction) was much higher compared to that in the Y direction (across flight direction). Noisy points were mostly of large range measurements, thus suggesting issues with the system calibration parameters and/or trajectory that affect the along flight direction more than the across flight direction. As for the UAV-2022 dataset, due to inaccurate mounting parameters, dual versions of the tree trunk can be observed in both the X and Y directions.

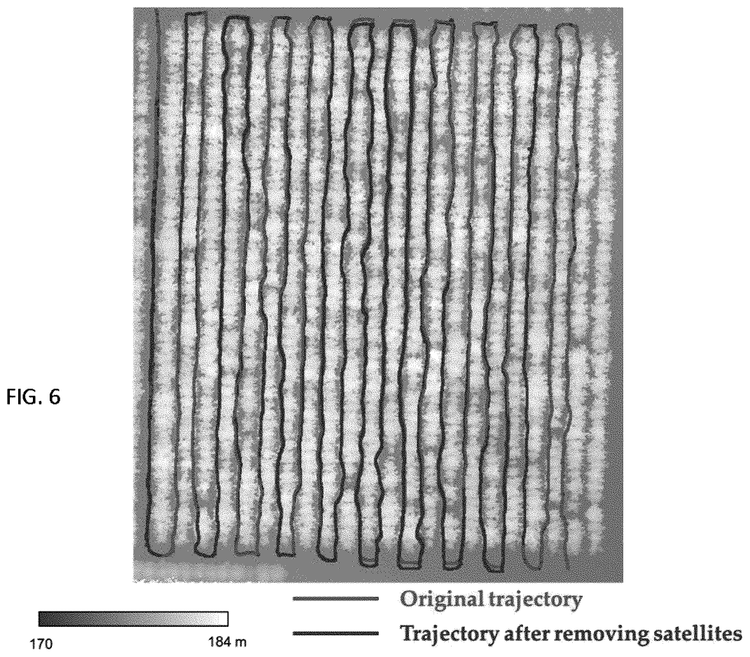

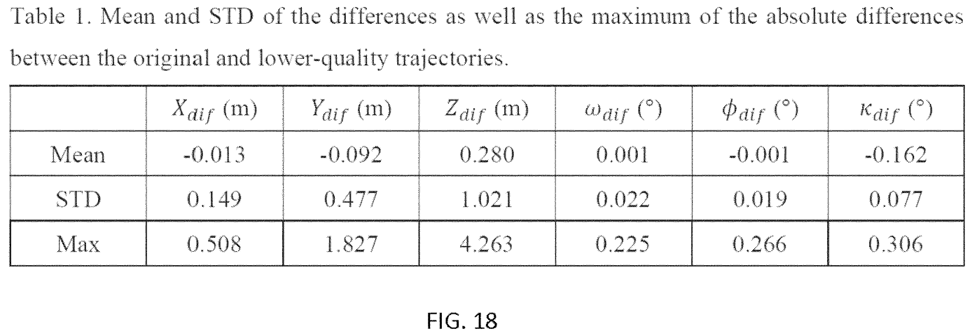

For the BP-2021 dataset, the BP system was carried while walking under the forest canopy (under-canopy) between individual tree rows. The mission included twenty-two north-south tracks each lasting about 2.5 mins. At the end of each track, the operator walked out of the canopy under open sky before the next track. This data acquisition pattern ensured reasonable quality trajectory without a dramatic increase in drifting errors over time. To evaluate the performance of the proposed framework on the BP dataset using trajectories with different levels of quality, two trajectory versions were derived through GNSS/INS post processing in Inertial Explorer® (IE) software developed by Novatel. The first trajectory version (denoted original trajectory) was generated using the IMU measurements along with GNSS observations from all available satellites. The number of tracked satellites ranged from 3 to 5 and 9 to 11 when walking under and outside the canopy, respectively. This original trajectory was assumed to have reasonable accuracy. The largest expected standard deviations from IE were ±0.4 m for the Z coordinate and ±0.04° for the heading angle. To simulate a situation with more severe GNSS signal outages, the second version of trajectory (denoted lower quality trajectory) was derived using the IMU measurements while removing GNSS observations from 5 satellites between the 4th and 19th tracks during IE post processing. In this case, the largest expected standard deviations were ±0.1.2 m for the Z coordinate and ±0.05° for the heading angle. FIG. 6 shows the two versions of trajectory where obvious differences can be observed for the tracks in the middle of the study site. Table 1 (FIG. 18) presents the mean and standard deviation (STD) of the differences as well as the maximum value of the absolute differences between the two trajectories. As expected, significant deteriorations were introduced when removing the five satellites during GNSS/INS post processing, especially in the Y (i.e., walking direction) and Z coordinates.

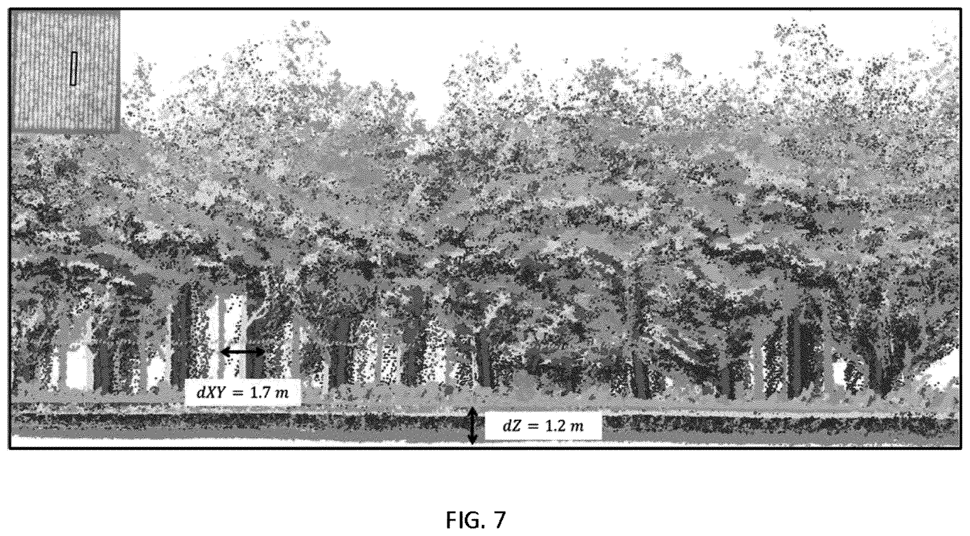

To illustrate the impact of GNSS signal outage, a small region of interest (ROI) in the middle portion of Row 13 (from the west) within the forest plantation was cropped from the BP point cloud generated from the original trajectory, as shown in FIG. 7. The ROI chosen for examination was in the middle portion of the whole area. A spatial misalignment of about 1.7 m in the horizontal direction and 1.2 m in the vertical direction can be observed in the point cloud using the original trajectory with reasonable accuracy. The point cloud reconstructed from the lower quality trajectory had more significant misalignment. It is worth mentioning that the mounting parameters of the BP system were calibrated and the sensor to object distances during the data acquisition were quite close. In this case, the impact of potential errors in the mounting parameters on the 3D coordinates of LiDAR points was negligible compared to that caused by the inaccurate trajectory. Therefore, trajectory enhancement was the focus for the BP-2021 dataset while the mounting parameters were assumed errorless in the investigations.

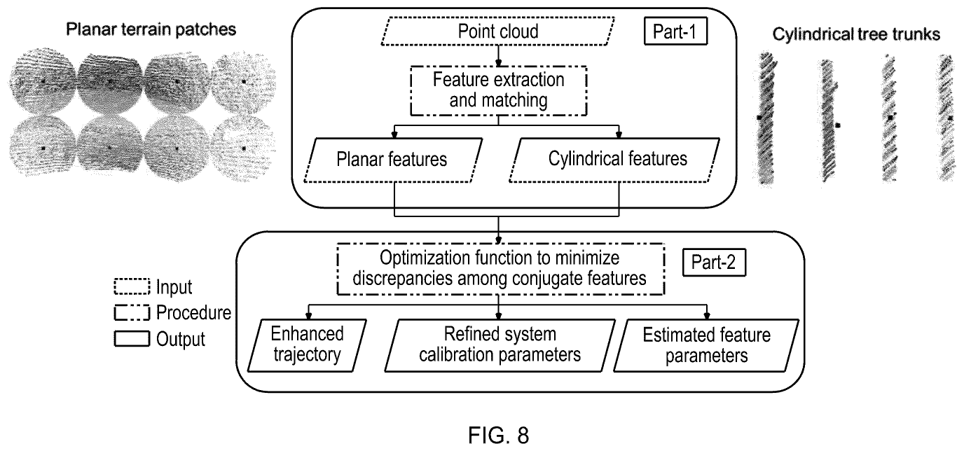

For the investigations, a system-driven approach was proposed for calibration and GNSS/INS trajectory enhancement that can mitigate any misalignment within the point cloud caused by inaccurate LiDAR mounting parameters and/or GNSS signal outages. The proposed strategy was based on the hypothesis that any inaccuracy related to mounting parameters and trajectory information would manifest in the point cloud as discrepancies among conjugate features, as discussed below. The framework for the proposed approach is depicted in FIG. 8. This approach utilizes common features that can be automatically identified and extracted from point clouds. In this study, terrain patches and tree trunks were used as planar and cylindrical features, respectively for the refinement of system calibration and trajectory parameters. Part 1 of the flowchart in FIG. 8 focuses on extracting and matching planar and cylindrical features, and Part 2 of FIG. 8 shows the optimization framework for system calibration and trajectory enhancement. The output of the optimization process includes refined mounting parameters, enhanced trajectory parameters (position and orientation), and estimated feature parameters for each planar/cylindrical primitive.

The following discusses a strategy for extracting and matching planar features (terrain patches) and cylindrical features (tree trunks) from point clouds captured by different LiDAR MMS. The prerequisite for reliable feature extraction was that the used point cloud has a relatively good quality within a short time interval. In the investigations, with continuous accessibility to GNSS signal, the UAV systems produced LiDAR point clouds with reasonable quality. Therefore, the feature extraction was directly conducted on the entire point cloud for the UAV-2021 and UAV-2022 datasets. On the other hand, by assuming that the point cloud from a single track of the BP dataset had relatively good quality, feature extraction was performed on each track for the BP-2021 dataset.

The point clouds (either the entire point cloud for UAV datasets or individual tracks for the BP dataset) were reconstructed using the initial GNSS/INS trajectory and system calibration parameters. Then, a ground filtering algorithm was applied to generate a digital terrain model (DTM) and separate bare earth points from above ground ones. More specifically, LiDAR points whose heights were no more than a certain value (e.g., 0.5 m) above the DTM form the bare earth point cloud, while the remaining ones were extracted as the above ground point cloud. The bare earth point clouds were used for terrain patch extraction and matching, as will be discussed below. The above ground point clouds were used for conducting individual tree detection/localization followed by tree trunk extraction and matching, as will also be discussed below.

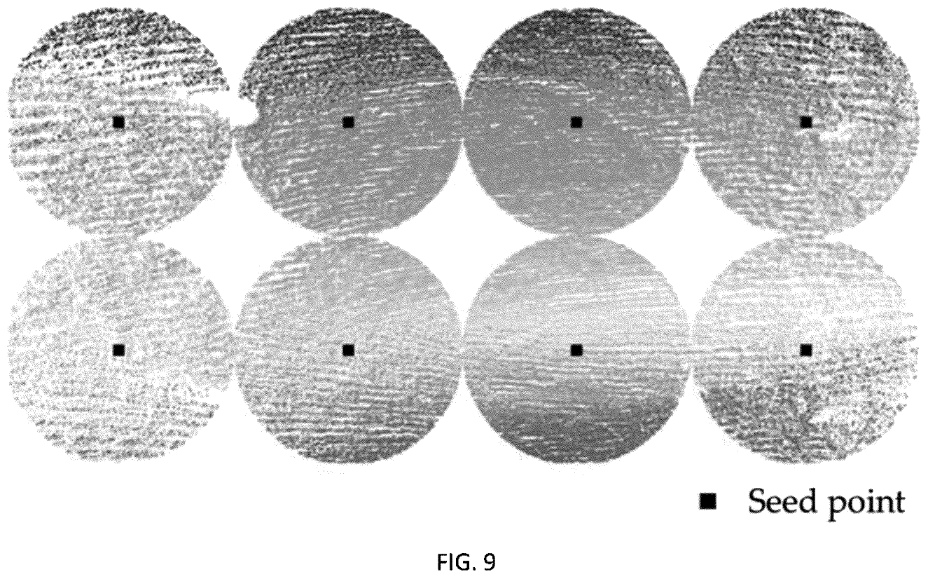

Despite the varying size and shape of above ground forest entities, ground can be approximated as a plane within a local neighborhood. Terrain patches (small segments of the bare earth point cloud in a local area), extracted and matched between individual tracks and/or different datasets, were used as planar features to provide vertical control for system calibration and trajectory enhancement. To extract terrain patches from a given point cloud, regularly spaced 2D seed points were generated over the ROI where the Z coordinates were derived from the DTM. For each seed point, its neighboring points within a given search radius were identified from the bare earth point cloud. The dimensionality based analysis was conducted to test the planarity of the local neighborhood. Iterative plane fitting—multiple iterations of plane fitting followed by outlier removal based on the root mean square (RMS) of the fitting error—was performed to estimate the plane parameters. Through a sequential-augmentation process, segmented points and parameters describing the respective plane model were derived. FIG. 9 shows sample terrain patches extracted from one track of the BP-2021 dataset. Once the terrain patches from different point clouds were extracted, features that meet the following criteria were matched: (a) they were extracted from the same seed point; and (b) the angle between their normal vectors was smaller than a user defined threshold.

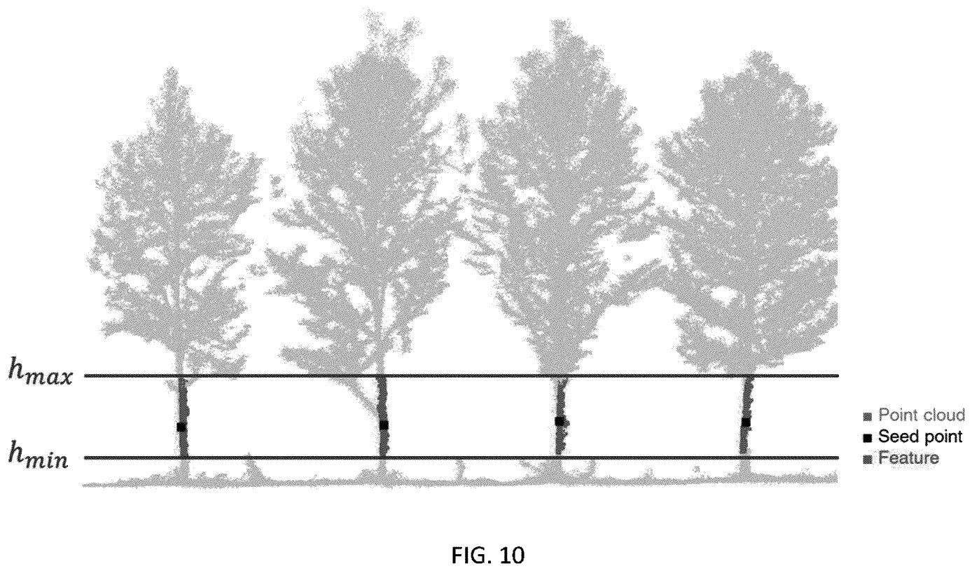

Tree trunks were used as cylindrical features to provide horizontal control as they were distinct objects and their planimetric locations remain the same over time. Tree trunk extraction starts by isolating the lower portion of above ground point cloud (hereafter denoted as hypothesized trunk portion) based on user defined minimum and maximum height thresholds of hₘᵢₙ and hₘₐₓ (e.g., 1.5 m and 3.5 m) above the DTM, as shown in FIG. 10. A tree detection and localization approach was adopted to identify individual trees in the hypothesized trunk portion. The approach utilized a grid based evaluation of the sum of normalized elevations relative to the ground level of all points to identify local peaks that will be designated as tree trunk locations. Detected planimetric locations were then used as seed points to identify corresponding LiDAR points from the hypothesized trunk portion. More specifically, for a detected tree, its planimetric location (Xₜ, Yₜ) was used to derive the ground height Z_{G} from the DTM. Then, a seed point that corresponds to the tree trunk portion was defined as (Xₜ, Yₜ, ZG+ΔZ), where ΔZ is a user-defined height above ground (in the investigations, AZ was chosen to be somewhere between the hₘᵢₙ and hₘₐₓ values; e.g., 2.5 m). For each seed point, a spherical region with a predefined radius (e.g., 0.5 m) was created. LiDAR points from the hypothesized trunk portion within this spherical region were used to determine whether a linear/cylindrical feature existed or not through the dimensionality-based analysis. If a linear/cylindrical feature existed, the parameters of the best fitting cylinder were estimated via an iterative model fitting and outlier removal process. A region growing was then performed to sequentially augment neighboring points that belong to the current feature if their normal distances from the fitted cylinder were smaller than a multiplication factor times the RMS of the fitting error. The augmentation proceeded until no more points could be added to the feature in question. The output of the feature extraction included the segmented points and parameters describing the respective cylinder model. FIG. 10 shows sample tree trunks extracted from an individual track of the BP-2021 dataset. Once tree trunks from all point clouds were extracted, conjugate features were matched if the planimetric distance between two seed points (i.e., the detected tree locations) was less than a distance threshold and the angle between the two cylinder axes was smaller than an angle threshold.

Extracted and matched planar/cylindrical features from single or multiple datasets were used to: (a) refine the system calibration parameters, (b) enhance the quality of the GNSS/INS trajectory, and (c) improve the point cloud alignment. Conceptually, the proposed optimization framework aimed at minimizing the normal distance between LiDAR points and the respective parametric models for planar/cylindrical features by refining system calibration and trajectory parameters through a nonlinear LSA. The point positioning equation was the basis of this optimization framework. For any LiDAR point I captured at time t, its coordinates in the mapping frame (r_{I}^{m}(t)) were defined by the trajectory position and orientation parameters at the corresponding time (r₍ₜ₎^{m},R_{b(t)}^{m}) LiDAR mounting parameters including lever arm and boresight angles (rₗᵤ^{b},Rₗᵤ^{b}), and laser unit frame coordinates of the point (r_{I}^{lu(t)}) derived from raw LiDAR measurements at the firing time (evaluated using range measurement and orientation of the laser beam relative to the laser unit reference frame). The mathematical model is expressed symbolically in Equation (1). The corrected coordinates of the same point after system calibration and trajectory enhancement will depend on the refined mounting parameters (rₗᵤ^{b}(refined),Rₗᵤ^{b}(refined)) and estimated corrections to the trajectory position/orientation parameters (δr_{b(t)}^{m}, δR_{b(t)}^{m}) as expressed in Equation (2).

$${r}_{\text{?}}^{m} ( t ) = f ( {r}_{b ( t )}^{m} , {R}_{b ( t )}^{m} , {r}_{lu}^{b} , {R}_{lu}^{b} , {r}_{\text{?}}^{lu ( t )} ) \qquad ( 1 )$$

$${{r}_{\text{?}}^{m} ( t )}_{corrected} = f ( {r}_{b ( t )}^{m} , {r}_{b ( t )}^{m} , {R}_{b ( t )}^{m} , δ {R}_{b ( t )}^{m} , {r}_{\text{?}}^{b} ( refined ) , {R}_{\text{?}}^{b} ( refined ) , {r}_{\text{?}}^{lu ( t )} ) \qquad ( 2 )$$

$$\text{?} \text{indicates text missing or illegible when filed}$$

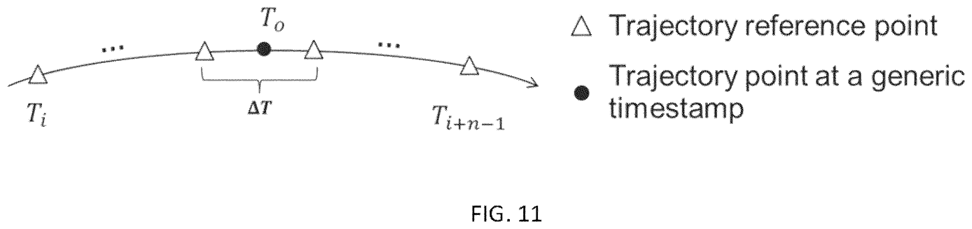

Solving for the trajectory corrections at every timestamp of laser beam firing was not done since it would cause over parametrization in the LSA. Since the platform has a relatively smooth trajectory with moderate dynamics, the original high frequency (e.g., 100-200 Hz) trajectory was down-sampled to a user defined, lower frequency (i.e., using a down sampling time interval ΔT). The down-sampled trajectory points were henceforth denoted as trajectory reference points, as shown in FIG. 11. The corrections to the trajectory parameters at a specific laser beam firing timestamp were then modeled as p^{th}-order polynomial functions of estimated corrections for their n trajectory reference points. Symbolically, this polynomial modeling is expressed in Equation (3), where it can be seen that for a generic timestamp, T₀, its trajectory corrections (denoted generically as δθ_{b(T0)}^{m} are a function of the polynomial order along with the timestamps and trajectory corrections of its n neighboring trajectory reference points. The down-sampling time interval, polynomial order, and number of neighboring trajectory reference points were chosen based on the nature of platform dynamics.

$${δθ}_{b ( {T}_{0} )}^{m} = f ( p , {T}_{0} , {T}_{\text{?}} , {T}_{i + 1} , … , {T}_{\text{?} + n - 1} , {δθ}_{b ( {T}_{i} )}^{m} , {δθ}_{b ( {T}_{\text{?} + 1} )}^{m} , … , {δθ}_{b ( {T}_{\text{?} + n - 1} )}^{m} ) \qquad ( 3 )$$

$$\text{?} \text{indicates text missing or illegible when filed}$$

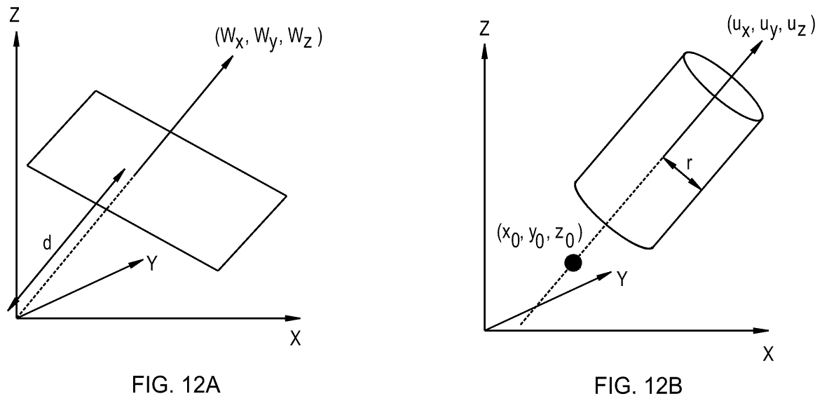

The mathematical model for the proposed LSA was comprised of two sets of constraints: (a) equations arising from LiDAR feature points and (b) equations incorporating prior trajectory information. The first set of constraint equations aims at minimizing the normal distance of each LiDAR point from the parametric model of its corresponding planar/cylindrical feature. The minimization function is expressed mathematically in Equation (4). Here, Fₖ^{m} denotes the feature parameters for the k^{th} feature in the mapping frame, nd(I, t, Fₖ^{m}) denotes the normal distance between the LiDAR point I at time t and its corresponding feature k. An a priori variance, denoted by σ_{nd}², is associated with each of these constraint equations to assign range-based adaptive weights to the normal distance for each LiDAR feature point. LiDAR feature points captured within a predefined range threshold from the LiDAR unit (ρₘₐₓ) were assumed to conform to their corresponding features more accurately than further points, which would be more prone to noise. The adaptive variance was defined according to Equation (5), which describes the assumption that points with a range less than ρₘₐₓ will have a constant variance of σ_{ref}² whereas points with a higher range will have a linearly increasing variance (or, lesser weight). Here, σ_{ref}² denotes the nominal expected accuracy for the LiDAR points and can be determined based on the manufacturer specifications of the involved sensors. The parameters describing a planar feature include the normal vector (wₓ, w_{y}, w_{z}) and its normal distance from the origin d, as shown in FIG. 12A; out of these four parameters, three can be designated as independent. In this work, w_{z} was fixed to 1 since the normal vectors of all terrain patches will have a predominant component along the Z axis. The parameters for a cylindrical feature include the direction vector of its axis (uₓ, u_{y}, u_{z}), a point on the axis (x₀, y₀, z₀), and radius r, as shown in FIG. 12B. Out of these parameters, there were only five independent ones—two out of (uₓ, u_{y}, u_{z}), two out of (x₀, y₀, z₀), r. Since the orientation of all tree trunks will be predominantly vertical, in the investigations, u_{z} and z₀ were fixed to 1 and 0, respectively.

$${arg min}_{{δθ}_{b ( {T}_{ref} )}^{m} , δ {r}_{\text{?}}^{b} , δ {R}_{\text{?}}^{b} , {F}_{k}^{m}} {\sum }_{∀ LiDAR feature points} \frac{{( nd ( I , t , {F}_{k}^{m} ) )}^{2}}{{σ}_{nd}^{2}} \qquad ( 4 )$$

$${σ}_{nd}^{2} = {( \frac{max ( {ρ}_{max} , {ρ}_{i} )}{{ρ}_{max}} \times {σ}_{ref} )}^{2} \qquad ( 5 )$$

$$\text{?} \text{indicates text missing or illegible when filed}$$

A second set of constraint equations was introduced in the LSA to ensure that the corrections to the trajectory reference points were commensurate with provided information by the GNSS/INS post processing from absolute and relative points of view. In an absolute sense, constraint equations were introduced to minimize the change in position and orientation parameters δθ_{b(t)}^{m} for each trajectory reference point depending on the reported standard deviation by the GNSS/INS post processing, as given by Equation (6), where Nₜ denotes the total number of trajectory reference points. From a relative point of view, the change in the distance traversed between two consecutive trajectory reference points was minimized based on the reported velocity accuracy of the trajectory, as given by Equation (7). In this equation, Dᵢ denotes the distance between the positions of the i^{th} and (i+1)^{th} reference points. By including these constraint equations, the short term (mainly provided by the IMU) and long term (mainly provided by the GNSS) information from the GNSS/INS based trajectory were utilized together with the LiDAR observations to ensure the best accuracy of the enhanced trajectory. Adding the minimization constraints in Equation (6) and Equation (7) based on prior knowledge ensured that corrections to trajectory reference points would be zero if there were no LiDAR feature points to assist in their estimation (i.e., there were no feature points with timestamps associated with these reference points).

$${arg min}_{{δθ}_{{b ( t )}_{\text{?}}}^{m}} {\sum }_{i = 1}^{{N}_{\text{?}}} \frac{{( {δθ}_{{b ( t )}_{i}}^{m} )}^{2}}{{σ}_{{θ}_{\text{?}}}^{2}} \qquad ( 6 )$$

$${arg min}_{{r}_{{b ( t )}_{i}}^{m} , {r}_{{b ( t )}_{i + 1}}^{m}} {\sum }_{i = 1}^{{N}_{t} - 1} \frac{\begin{matrix}( {D}_{{i}_{corrected}} ( {r}_{{b ( t )}_{\text{?}}}^{m} , δ {r}_{{b ( t )}_{\text{?}}}^{m} , {r}_{{b ( t )}_{\text{?} + 1}}^{m} , δ {r}_{{b ( t )}_{i + 1}}^{m} ) - \\ {{D}_{i} ( {r}_{{b ( t )}_{\text{?}}}^{m} , {r}_{{b ( t )}_{i + 1}}^{m} ) )}^{2}\end{matrix}}{( {σ}_{v}^{2} )} \qquad ( 7 )$$

$$\text{?} \text{indicates text missing or illegible when filed}$$

Based on the above discussion, we can determine the total number of unknowns and constraint equations involved in the LSA model for dataset(s) with N_{Lu} LiDAR units, Nₜ. trajectory reference points, npₚ LiDAR points captured over Nₚ planar terrain patches, and np_{c} LiDAR points captured over N_{c} cylindrical tree trunks. The unknowns included 6N_{Lu} LiDAR mounting parameters, Nₜ trajectory reference point corrections to position/orientation parameters (σθ), 4Nₚ planar terrain patch feature parameters (one for each planar feature was fixed), and 7N_{c} cylindrical tree trunk feature parameters (two for each cylindrical feature were fixed). It is worth mentioning that due to potential correlation between LiDAR mounting parameters and trajectory information, conducting system calibration and trajectory enhancement simultaneously could lead to inaccurate estimation of the involved parameters. Therefore, in case both tasks were required, system calibration would be performed while fixing the trajectory information, followed by trajectory enhancement while fixing the refined mounting parameters.

The estimation of the system calibration parameters and trajectory corrections was based on the contribution of the LiDAR constraints, Equation (4). The effective contribution towards LSA was only along the normal direction(s) to the feature. Hence, there would be an effective contribution of one equation per LiDAR point captured over a planar or cylindrical feature, thus resulting in a total of npₚ and np_{c} constraint equations from LiDAR points along terrain patches and tree trunks, respectively. Additionally, there will be 6Nₜ and (Nₜ−1) constraint equations based on prior absolute and relative trajectory information, respectively. The LSA for system calibration and trajectory enhancement was conducted iteratively until the change in the RMS of normal distances of the LiDAR points from the corresponding features was less than a predefined threshold.

The proposed system calibration and trajectory enhancement strategy including feature extraction, matching, and optimization framework offers several salient features. First, the constraint equations are not restricted to a single platform/sensor/dataset. The LSA model can be used to conduct a simultaneous multi sensor, multi temporal, multi-platform system calibration and trajectory enhancement. Second, the approach allows using one or more systems with accurate system calibration parameters and trajectory as a reference to refine the respective parameters for other systems. In order to accomplish this, the system calibration parameters and trajectory parameters for the reference system(s) were fixed (or assigned low a priori variance) in the LSA model while the parameters for other systems were estimated. For instance, in the investigations, the UAV MMS dataset with relatively accurate trajectory information could be used as a reference while conducting trajectory enhancement for the BP MMS dataset with poor quality trajectory. Third, the proposed strategy could be used for refining system calibration parameters and enhancing the trajectory information for one or more systems without including any reference system with accurate trajectory (e.g., UAV datasets in the investigations).

The following presents experimental results to validate the system calibration and trajectory enhancement strategy in terms of the improvement in the alignment of UAV and BP MMS point clouds. Since the alignment of UAV point clouds was reasonable (due to continuous access to GNSS signal as discussed above), terrain patches and tree trunks were extracted from the entire UAV-2021 and UAV-2022 datasets. Therefore, there was no need for intra-dataset feature matching. The used radius for the extraction of planar terrain patches was set to 1 m. For tree trunk extraction, the minimum and maximum height thresholds (hₘᵢₙ and hₘₐₓ) were set to 0.5 m and 2.5 m for the UAV-2021 dataset. Due to existing debris in the UAV-2022 dataset, the respective height range thresholds were set to 1.5 m and 3.5 m. A total of 3248 terrain patches were extracted from each of the UAV datasets, while 843 and 540 tree trunks were identified in the UAV-2021 and UAV-2022 datasets, respectively. The fewer tree trunks in the UAV-2022 dataset were due to the conducted thinning activity prior to this acquisition.

For the BP-2021 dataset, the individual tracks were reconstructed using the original GNSS/INS trajectory (the beginning and end of each track could be automatically identified based on the available trajectory). Then, feature extraction was conducted on each track separately. The parameters for feature extraction were set similar to those for the UAV-2021 dataset. Then, an intra dataset, across track matching was conducted. Due to the large misalignment ranging up to 1.7 m in the point cloud (as shown in FIG. 7), some tree trunk mismatches were observed. Therefore, a manual quality control was conducted to assess the accuracy of tree trunk matching before using them for trajectory enhancement. In total, 3248 terrain patches and 929 tree trunks were established for the BP dataset. Since part of the investigations aimed at investigating the impact of integrating UAV and BP point clouds for trajectory enhancement of the latter, features from the BP 2021 and UAV-2021 datasets were matched, resulting in 3041 and 817 common terrain patches and tree trunks, respectively. The unmatched features between these datasets were still used in the LSA as they would still contribute towards the estimation of dataset/system specific parameters.

The expected accuracy of post LSA normal distance related to the planar and cylindrical features (σ_{ref}) was set to 5 cm. While conducting trajectory enhancement for UAV and BP datasets, the trajectory reference points were established at a frequency of 1 Hz (the frequency of the original trajectory was 200 Hz and 100 Hz for the UAV and BP systems, respectively). Corrections to the position and orientation parameters at the laser beam firing timestamps were established using those associated with the three neighboring reference points through a second 551 polynomial function. The performance of the proposed system calibration and trajectory enhancement approach was evaluated as follows:

Estimated trajectory corrections: The evaluated corrections for the high frequency trajectory (i.e., following the interpolation process while using estimated corrections for the reference points) were used to illustrate the required trajectory changes to ensure better alignment for the point cloud. Statistical measures (mean, STD, and RMS) and magnitude of the corrections were reported in a tabular form and visualized using a color coded trajectory with the colors representing the magnitude of applied corrections.

Relative accuracy of derived point clouds: The relative accuracy was qualitatively assessed by checking the alignment of the point cloud in an individual dataset corresponding to a profile and/or individual trees. For quantitative assessment, statistical measures of normal distances between the LiDAR points and their respective best fitting plane/cylinder before and after trajectory enhancement were reported.

Absolute accuracy of derived point clouds: Since the two UAV datasets were collected in different years using different systems, well aligned point clouds from such datasets indicate that the conducted system calibration and trajectory enhancement framework achieved high absolute accuracy. Then, results from the UAV dataset were used as a reference to analyze the absolute accuracy of the BP point clouds after trajectory enhancement. The above comparison was performed qualitatively and quantitatively. The former was conducted by visually checking the alignment of point clouds from different datasets for a profile and/or individual trees. The latter utilizes the refined parametric model of extracted/matched terrain and tree trunk features for numerical evaluation of the quality in the Z and X/Y directions, respectively. More specifically, the X and Y coordinates of established seed points for terrain patch extraction were used to derive the Z coordinates from the respective refined plane parameters for each dataset. The differences between the Z values for each terrain patch represent the alignment degree in the vertical direction. For tree trunk features, a point on the refined cylinder axis was derived by setting a common Z coordinate for each dataset (e.g., the Z coordinate of the seed point used for tree trunk extraction from the reference dataset). The derived X and Y coordinates of that point were regarded as the planimetric tree location. The absolute accuracy in the X and Y directions was then estimated using the planimetric distances between respective tree locations from different datasets.

The following discussion presents the sequential system calibration and trajectory enhancement results for the UAV datasets. Trajectory enhancement results for the BP dataset using different quality trajectories with/without UAV point cloud as a reference are subsequently discussed.

In the investigations, sequential system calibration and trajectory enhancement was conducted on each UAV dataset. More specifically, using extracted features, corrections to trajectory reference points were set to zero and fixed while estimating the system calibration parameters in the LSA (due to the acquisition under open sky conditions, observed misalignments were initially attributed to erroneous system calibration parameters). Upon convergence, the refined mounting parameters were fixed and then trajectory corrections were estimated in a second LSA round. The resulting point clouds were finally checked for any additional improvement. In the LSA process, LiDAR boresight angles (Δω, Δφ, Δκ), as well as lever arm components in the X and Y directions (ΔX and ΔY), were estimated. The Z lever arm component was fixed, as it requires vertical control, which was not available for these datasets.

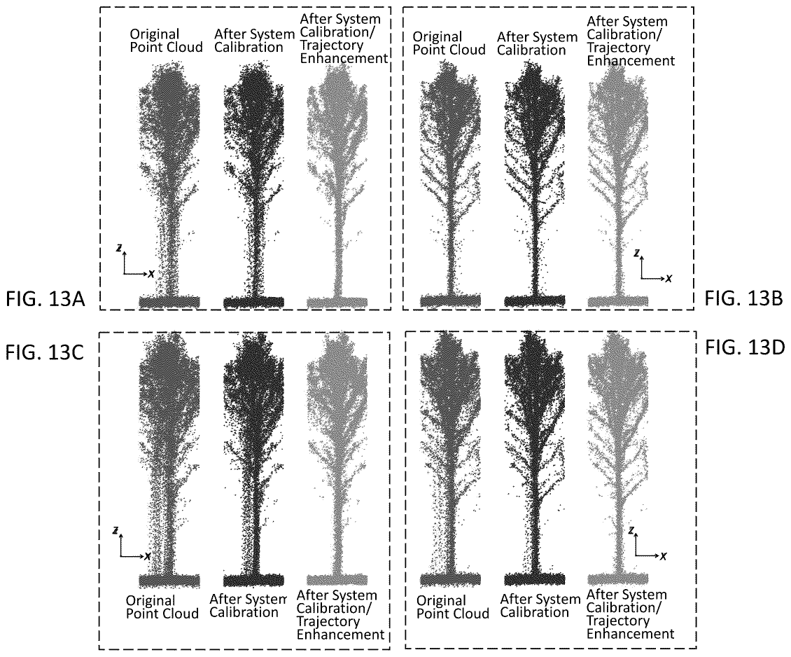

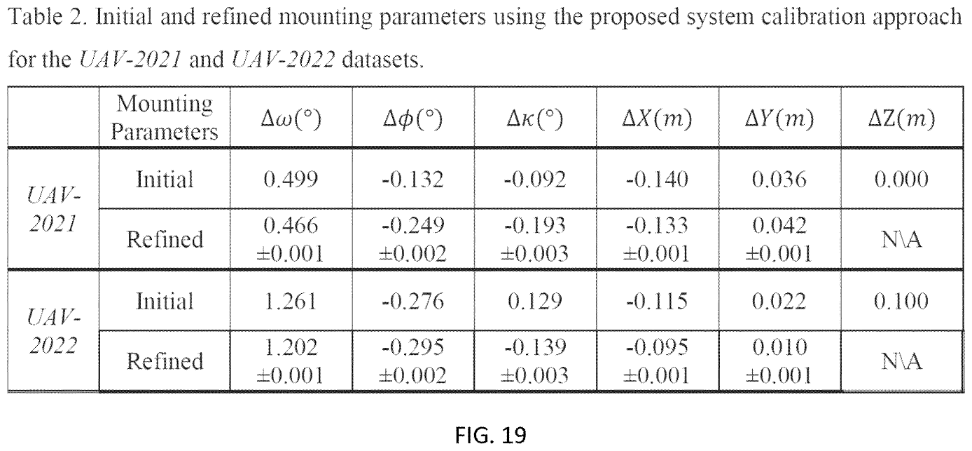

Initial and refined system calibration parameters, along with their STD values, were presented in Table 2 (FIG. 19), where one can see that the STD values for the estimated mounting parameters were small. Moreover, it has been observed that the estimated mounting parameters were not highly correlated. Based on the low correlation and small STD values of the estimated parameters, one can conclude that the LiDAR mounting parameters were accurately evaluated. Additionally, by comparing the refined mounting parameters with the initial ones in Table 2, one can see that the lever arm components remain relatively stable for the two systems. The boresight pitch (Δφ and heading (Δκ) angles of the UAV-1 system exhibited a change of 0.10°; however, the boresight heading (Δκ) angle of the UAV-2 system exhibit a change of 0.25°. When flying at 40 m above ground, a change of 0.25° in the heading angle would cause up to 0.5 m variation in the along-flight direction (X direction in the investigations) for a LiDAR point at the edge of the swath (i.e., at ±70° off-nadir). To evaluate the improvement after system calibration, FIGS. 13A through 13D show a sample tree from the two UAV datasets using the initial (in red) and refined (in blue) mounting parameters. It can be seen in FIGS. 13A through 13D that the misalignment in the UAV-2021 dataset decreased slightly after the system calibration. However, the level of alignment in the X direction was still worse than that in the Y direction. This observation suggests that a trajectory enhancement might be still required to achieve better quality point cloud. For the UAV-2022 dataset, the alignment improves more significantly in both X and Y directions. Similar to the UAV-2021 dataset, a trajectory enhancement process might be still needed.

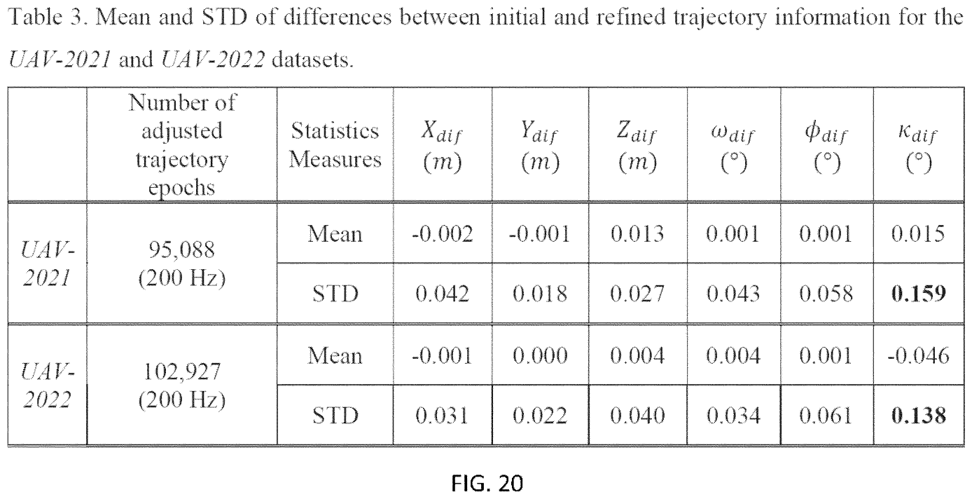

Once the trajectory enhancement was conducted through a second LSA round while fixing previously estimated mounting parameters, corrected reference points were used to derive the trajectory information at the original data rate (200 Hz) through the utilized second order polynomial function. Table 3 (FIG. 20) presents the mean and STD of the differences between initial and refined position/orientation parameters for the UAV datasets. These statistics were derived while considering only trajectory epochs associated with the used calibration/trajectory enhancement primitives (hereafter, denoted as adjusted trajectory epochs). The mean difference values for all parameters were close to zero for the two datasets. The STD values for the position differences were within 4 cm, which was at the same level as the nominal positional accuracy of the GNSS/INS unit. In terms of the orientation parameters, the heading angle (κ) had the largest STD value (Table 3), which can be explained by the relatively lower accuracy of trajectory heading when compared to the roll/pitch angles provided by the GNSS/INS integration. The impact of an inaccurate heading angle on LiDAR points was along the flying direction (X coordinate in the investigations). This level of heading correction explains the origin of the previously observed worse alignment in the X direction (along flight direction) in FIGS. 13A through 13D. This was confirmed through the improved quality along the X direction for the sample tree in FIGS. 13A through 13D after conducting the sequential system calibration and trajectory enhancement. Improvements can also be observed in the Y direction for the UAV-2022 dataset. In general, after trajectory enhancement, the levels of alignment in the X and Y directions for both datasets were quite similar, which was expected given the similar specifications of both data acquisition systems.

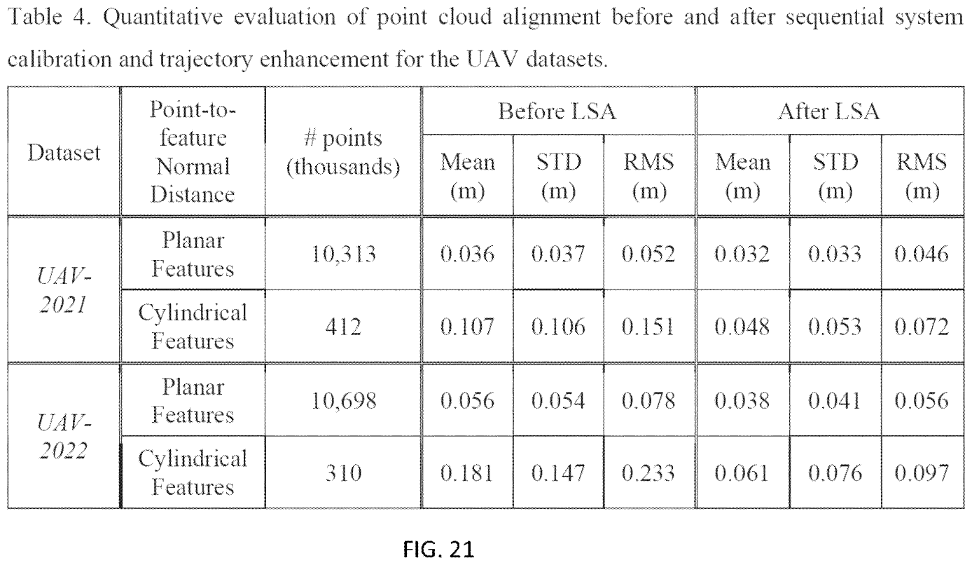

The performance of the proposed system calibration and trajectory enhancement was evaluated quantitatively through Table 4 (FIG. 21), which reports the mean, STD, and RMS values of normal distances between the LiDAR feature points and their corresponding best fitting plane/cylinder before and after the two step LSA. The RMS of normal distances before the LSA indicates that the initial point cloud alignment for the UAV-2021 dataset was better than that of the UAV-2022 dataset (this was mainly due to the outdated nature of the system calibration for the latter). Major improvements can be observed in the alignment of tree trunks after the LSA for both UAV datasets. The RMS value of the normal distances associated with cylindrical features for the UAV-2021 dataset was 2 cm smaller than that for the UAV-2022 dataset. This was mainly due to the larger height range (i.e., 1.5 m to 3.5 m) used for extracting tree trunk features in the latter dataset to avoid the inclusion of existing debris within the tree trunk features. As a result, more LiDAR points along tree branches were mistakenly extracted as tree trunks, which leads to larger point to cylindrical feature normal distance.

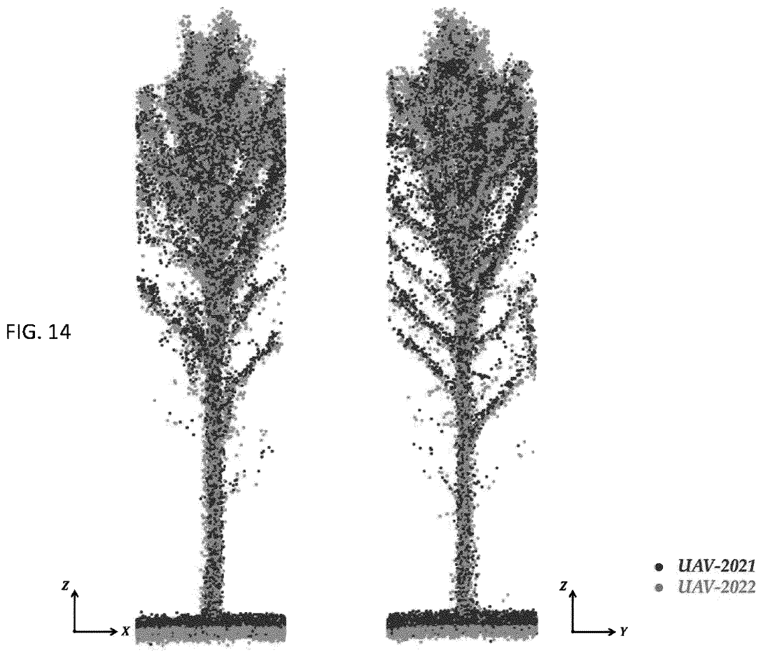

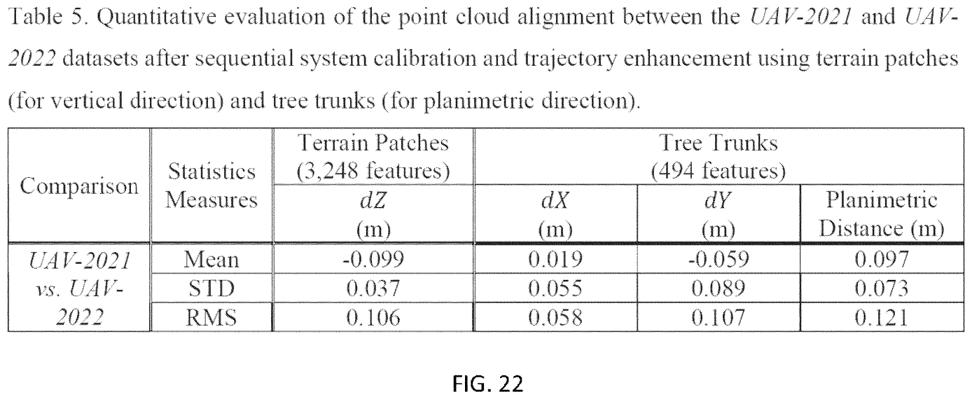

The above evaluation focused on the relative accuracy of each UAV dataset. The accuracy of the point clouds after the proposed system calibration and trajectory was validated by analyzing the agreement of point clouds from different datasets. FIG. 14 shows the sample tree after sequential system calibration and trajectory enhancement of the UAV-2021 and UAV-2022 datasets. It is clear in FIG. 14 that the tree trunk and branches align well in both X and Y directions. The alignment in the Z direction was slightly worse that in the X and Y directions (around an 8 cm Z shift between the two datasets). This was because the lever arm Z components of the two UAV systems were derived through measurements and fixed in the LSA. Moreover, lower alignment quality in the Z direction be attributed to falling leaves and debris on the plantation floor. Table 5 (FIG. 22) presents the evaluation of the point cloud alignment using the extracted features. In the vertical there was a shift of 10 cm between the two point clouds, which was in agreement with the discrepancies in FIG. 14. For the derived tree trunks, the mean, STD, and RMS values the X and Y coordinate differences as well as the planimetric distances between tree locations suggest that the tree locations were in agreement with an accuracy of 0.1 m. This planimetric alignment was slightly worse than what has been observed through visual check. Through closer inspection of the point clouds, the large planimetric distances between conjugate tree trunks were mainly caused by the mistakenly extracted branches in the UAV-2022 dataset. Overall, it was concluded that after conducting the LSA using the proposed framework, the point clouds from the UAV systems achieved high relative and absolute accuracy. Hereafter, refined point cloud from the UAV-2021 dataset was used as a reference to evaluate the performance of trajectory enhancement for the BP dataset, which are presented below.

For the BP-2021 dataset, two trajectory versions were generated to evaluate the performance of the proposed approach in handling trajectories with different quality. More specifically, the intent was to evaluate the impact of the BP trajectory quality on improving the relative and absolute alignment of the point clouds without the need for UAV data. In the investigations, the conducted experiments for the BP-2021 dataset were as follows:
Test 1: Trajectory enhancement using original trajectory with frequent access to open sky areas at the beginning and end of individual tracks.
Test 2: Trajectory enhancement using lower quality trajectory to simulate scenarios with extended periods of GNSS signal outages.
Test 3: Trajectory enhancement using the BP data with lower quality trajectory aided by the UAV-2021 dataset. More specifically, LiDAR features from the BP and UAV datasets were simultaneously included in the LSA. In this test, the refined mounting parameters and trajectory for the UAV-2021 dataset were treated as errorless.

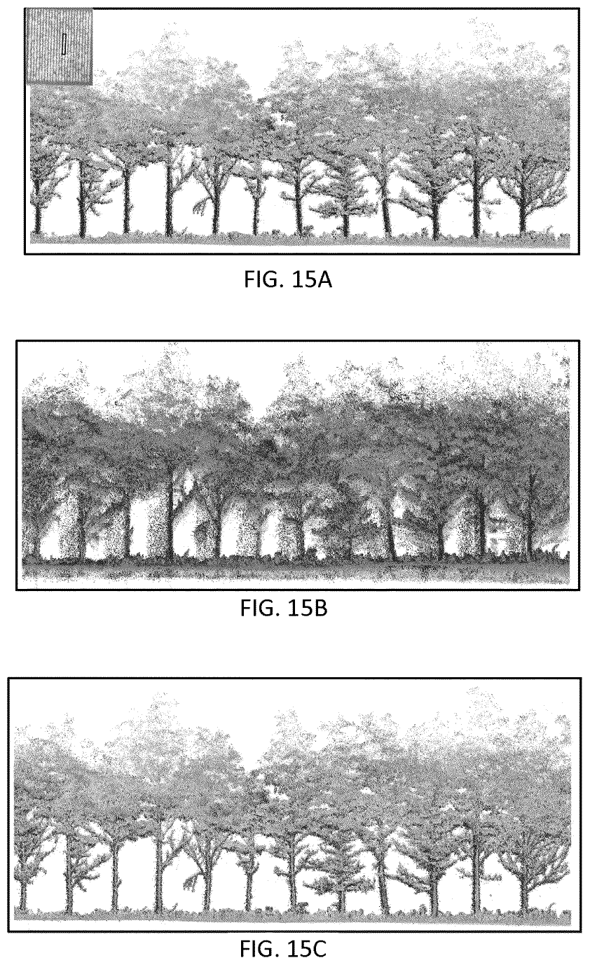

The relative accuracy of the BP point clouds after trajectory enhancement was evaluated first. FIGS. 15A through 15C show a profile from the BP-2021 dataset after trajectory enhancement for the conducted tests. Compared to the derived point cloud using the original trajectory (as shown in FIG. 7), drastic improvements can be observed for the BP point clouds after trajectory enhancement for Test 1 (as shown in FIG. 15A). The initial misalignment of 1-2 m was significantly reduced, where the definition of tree trunks and branches was quite clear. However, when the trajectory enhancement was conducted using the lower quality trajectory (i.e., Test 2), the results were relatively inferior. This can be observed in FIG. 15B where a significant number of noisy points were visible in the profile and the terrain was much thicker compared to that in FIG. 15A, indicating a lower quality alignment. To improve the performance of Test 2, Test 3 utilized the refined point cloud from the UAV-2021 dataset as a reference and the results in FIG. 15C reveal that the BP point cloud alignment reaches the same level as that in Test 1.

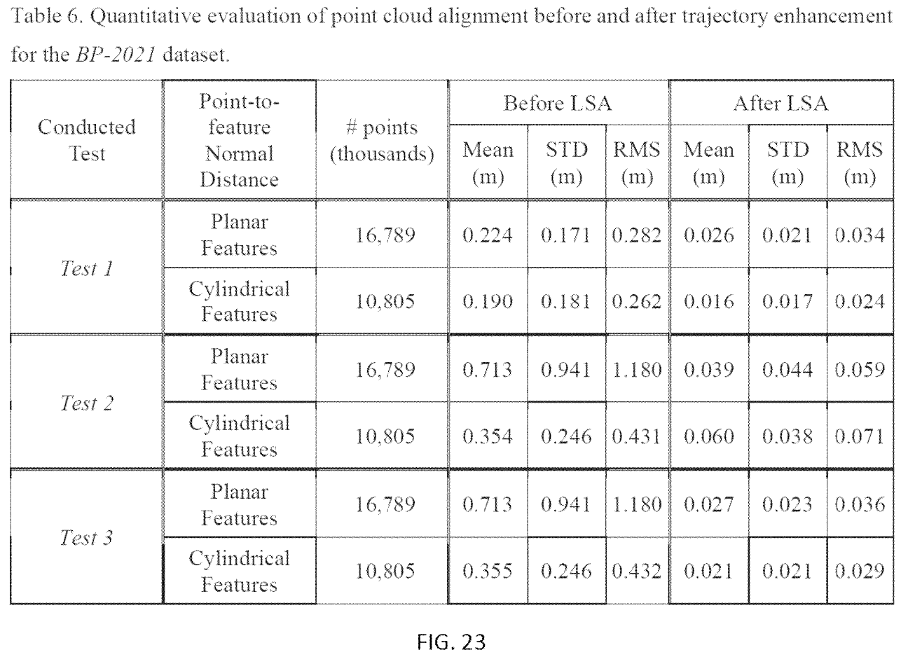

The above findings were also verified through a quantitative evaluation as presented in Table 6 (FIG. 23), which reports the mean, STD, and RMS values of normal distances of the LiDAR points to their corresponding best fitting plane/cylinder before and after the LSA process for the three tests. The RMS of normal distances before trajectory enhancement indicates that the initial BP point cloud alignment for Test 1 using the original trajectory was much better than that for Tests 2 and 3 using the lower quality trajectory, which was expected due to the impact of removing 5 GNSS satellites during the GNSS/INS integration. The RMS values after trajectory enhancement for Test 1 show that the adjustment process attains an overall accuracy of 3.4 cm and 2.4 cm for planar and cylindrical features, respectively. While using the lower quality trajectory, the RMS values from Test 2 were 5.9 cm and 7.1 cm, which were higher than those from Test 1. As for Test 3, with the help of UAV point clouds, the alignment of the BP point cloud was at the same level as Test 1. Overall, it can be concluded that both Tests 1 and 3 achieved high relative accuracy for the BP732 dataset. More specifically, for a BP dataset with lower quality trajectory data, a reference data such as that provided by the UAV was needed to improve the relative alignment. Therefore, the following analysis will only be focusing on these two tests.

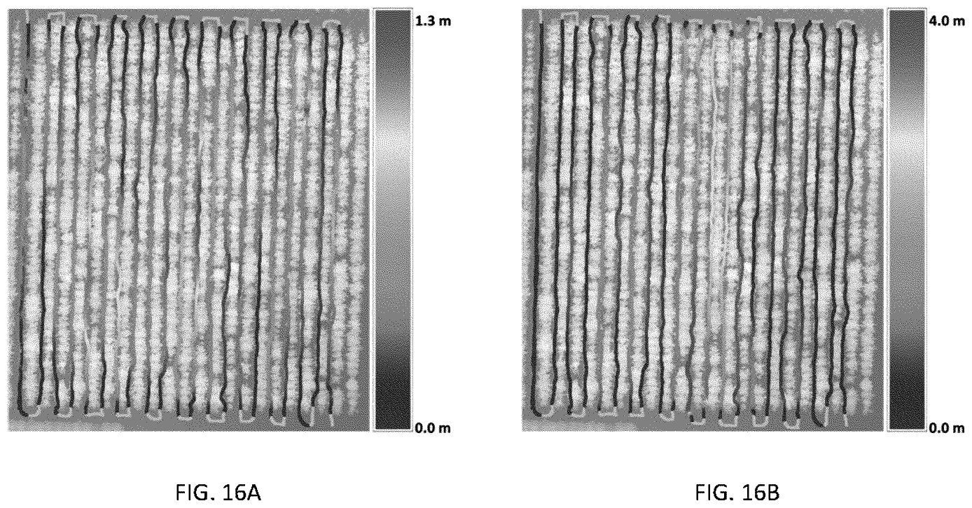

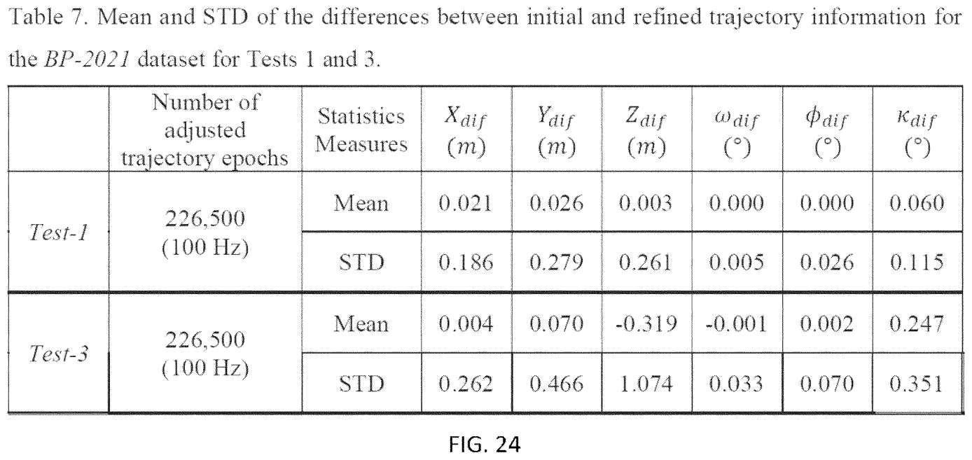

FIG. 16A and FIG. 16B portray the enhanced BP trajectory colored by the magnitude of estimated corrections to the position parameters for Tests 1 and 3, respectively. Trajectory epochs that do not correspond to any of the LiDAR features used in the LSA (i.e., unadjusted trajectory points) are colored in grey; as it was mentioned earlier, the position/orientation information for these epochs was maintained at the same value as the original trajectory. For Test 1, FIGS. 16A and 16B clearly indicate higher correction magnitudes at the middle portion of the canopy compared to the north and south edges where the GNSS signal reception was better. The largest magnitude of positional corrections was around 1.3 m. For the lower quality trajectory, the corrections were much larger. It can be observed in FIG. 16B that the largest corrections (around 4 m) take place at the middle tracks where drift errors caused by GNSS signal outages accumulate the most. Statistics of trajectory corrections are presented in Table 7 (FIG. 24), where the mean and STD values for the adjusted trajectory epochs are reported. The STD values for the position differences of Test 1 are in the range of 20 cm to 30 cm, which are much higher than the values for the UAV datasets (shown in Table 3). For Test 3 starting from the lower quality trajectory, the STD values increase by 20 cm and 70 cm in the Y and Z coordinates, respectively. Also, the corrections to the Z component have a mean value of 30 cm. Such statistics are in agreement with the findings discussed above confirming that removing satellites leads to significant deterioration in the Z coordinates of the post processed GNSS/INS trajectory, followed by the Y coordinates. For the orientation parameters, like the UAV datasets, the heading angle (u) showed the largest corrections. The differences between orientation corrections for Tests 1 and 3 were not as significant as the ones for the positional components. This signified that for this dataset, GNSS signal outages affected the positional component of the trajectory more than the orientation one.

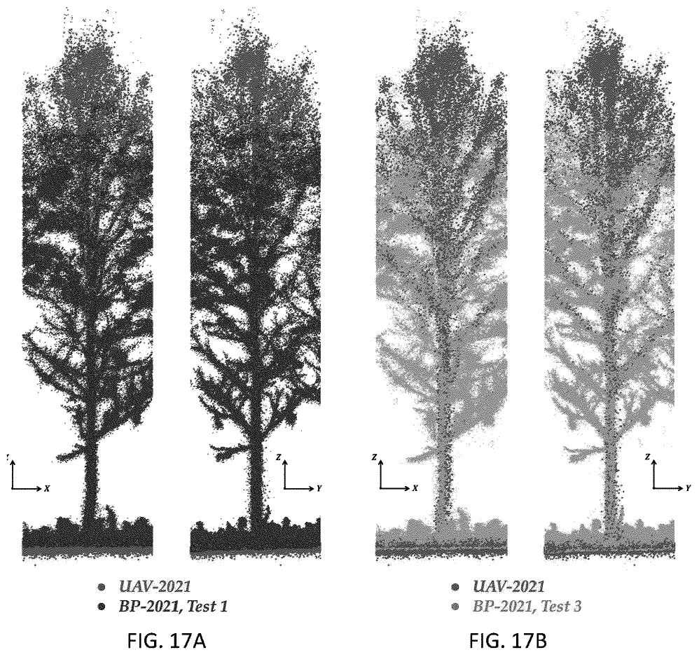

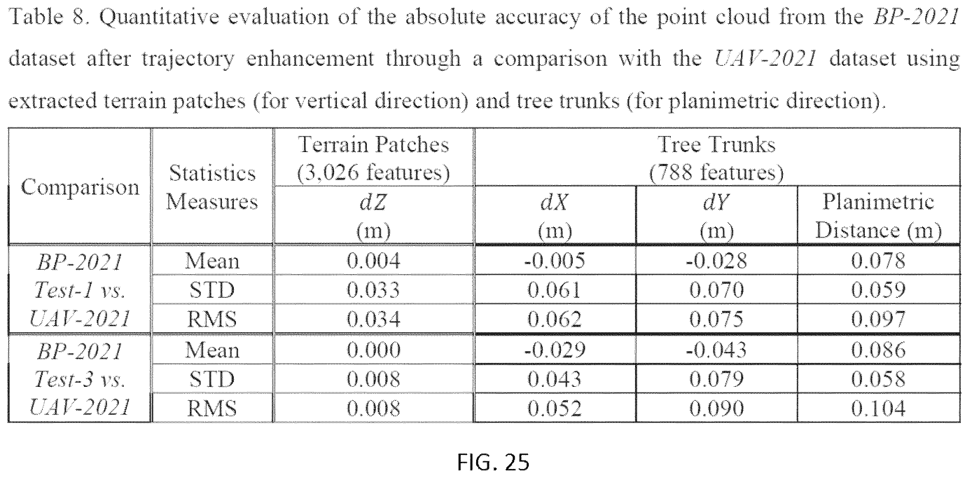

Lastly, the absolute accuracy of the BP point cloud after trajectory enhancement was evaluated through a comparison with the refined point cloud from the UAV-2021 dataset, which has already been proven to be of high relative/absolute accuracy. FIGS. 17A and 17B show the sample tree after trajectory enhancement of the BP point cloud for Tests 1 and 3 overlaid with the refined UAV point cloud. It can be seen in FIGS. 17A and 17B that the tree trunk from the BP point cloud was in good agreement with the UAV-2021 dataset in both X and Y directions. For the vertical direction, Test 3, which included the UAV-2021 point cloud, provides slightly better alignment. Upon closer inspection of the terrain portion in the point clouds, understory vegetation was observed in the BP-2021 dataset. In spite of this, the proposed trajectory enhancement significantly improves the accuracy of the BP point cloud. Quantitative comparison between the BP and UAV point clouds was conducted using the terrain patches and tree trunks. Table 8 (FIG. 25) reports the Z differences between the terrain patches as well as X/Y differences and planimetric distances between estimated tree locations from the BP-2021 and UAV-2021 datasets. In Table 8, the alignment in the Z direction suggests that Test 1 achieved a vertical accuracy of 3.4 cm, while Test 3 provided even better results by including the UAV point cloud. The comparison of tree trunks reveals that the tree locations were in agreement with an accuracy of 0.1 m for both tests. Considering the noise level of the UAV point clouds as well as the mistakenly extracted branches in both datasets, the planimetric accuracy was considered to be quite reasonable. In summary, both Tests 1 and 3 achieved high relative and absolute accuracy for the BP-2021 dataset through the proposed trajectory enhancement strategy.

The investigations successfully evaluated a system-driven framework for system calibration and trajectory enhancement for LiDAR units mounted on UAV and BP MMS that was able to generate accurate point clouds for high resolution forest inventory. The strategy reconstructs point clouds using initial system calibration parameters and GNSS/INS trajectory. Terrain patches and tree trunks are then extracted and matched from the LiDAR point clouds. By minimizing the discrepancies among features from different tracks/datasets/systems while considering the absolute and relative positional/rotational information from the initial trajectory, system calibration parameters and trajectory information were refined through a nonlinear LSA. This strategy can be conducted on multi temporal, multi-platform datasets to ensure the best point cloud alignment. To evaluate the performance of the proposed strategy, two UAV and one BP datasets were used in the investigations. For the UAV datasets, sequential system calibration and trajectory enhancement were conducted to improve the accuracy of the point clouds while avoiding any potential correlation among system calibration and trajectory parameters. The results indicate that 10 high relative and absolute accuracy at the 10 cm range can be achieved. For the BP dataset under leaf on condition, two versions of trajectory—original and lower quality—were used. The trajectory enhancement using the original trajectory significantly improved the alignment of the BP point cloud, providing a relative and absolute accuracy of 3 cm and 10 cm, respectively. When using the lower quality trajectory, the performance of trajectory enhancement while only considering the BP dataset was poor. However, after using the refined UAV point cloud as a reference, similar performance was achieved as compared to the test using the original trajectory.

The system calibration and trajectory enhancement framework for forest plantations is capable of use as the foundation for accurate under-canopy mapping in rapidly changing natural forest environments. Further, modifications are possible to increase its robustness to false tree trunk matching in cases where high misalignment within the point cloud might lead to a version of any tree trunk being matched with one of its neighboring trees. Integrating raw IMU measurements, GNSS observations, and RGB imagery with LiDAR can potentially provide additional constraints to achieve trajectory with higher accuracy.

As previously noted above, though the foregoing detailed description describes certain aspects of one or more particular embodiments of the invention and investigations associated with the invention, alternatives could be adopted by one skilled in the art. For example, the functions of certain components could be performed by components of different construction but capable of a similar (though not necessarily equivalent) function. As such, and again as was previously noted, it should be understood that the invention is not necessarily limited to any particular embodiment described herein or illustrated in the drawings.

1. A LIDAR-based mapping method comprising:
acquiring a first initial data frame and a second initial data frame, wherein the first initial data frame and the second initial data frame are obtained based on point cloud data scanned by a LIDAR mobile mapping system having substantially continuous accessibility to a Global Navigation Satellite System (GNSS) signal;
extracting at least one of a planar feature and a cylindrical feature from the first initial data frame and at least one of a planar feature and a cylindrical feature from the second initial data frame according to a first predetermined algorithm;
matching the at least one of a planar feature and a cylindrical feature from the first initial data frame and the at least one of a planar feature and a cylindrical feature from the second initial data frame according to a second predetermined algorithm;
refining the matched at least one of a planar feature and a cylindrical feature from the first initial data frame and the at least one of a planar feature and a cylindrical feature from the second initial data frame by applying a non-linear least squares adjustment according to a third predetermined algorithm; and
outputting the refined and matched at least one of a planar feature and a cylindrical feature from the first initial data frame and the at least one of a planar feature and a cylindrical feature from the second initial data frame into a combined frame.

2. The LIDAR-based mapping method of claim 1, wherein the LIDAR-based mapping method generates under-canopy mapping in a forest environment.

3. The LIDAR-based mapping method of claim 2, wherein the LIDAR mobile mapping system comprises at least one of an unmanned aerial vehicle and a ground-based carrier for acquiring the first and second initial data frames.

4. The LIDAR-based mapping method of claim 2, wherein the LIDAR mobile mapping system comprises an unmanned aerial vehicle traveling above the canopy of the forest environment for acquiring the first initial data frame and a ground-based carrier traveling below the canopy of the forest environment for acquiring the second initial data frame.

5. The LIDAR-based mapping method of claim 4, wherein the ground-based carrier is a backpack.

6. A system-driven framework configured to:
acquire a first initial data frame and a second initial data frame, wherein the first initial data frame and the second initial data frame are obtained based on point cloud data scanned by a LIDAR mobile mapping system having substantially continuous accessibility to a Global Navigation Satellite System (GNSS) signal;
extract at least one of a planar feature and a cylindrical feature from the first initial data frame and at least one of a planar feature and a cylindrical feature from the second initial data frame according to a first predetermined algorithm;
match the at least one of a planar feature and a cylindrical feature from the first initial data frame and the at least one of a planar feature and a cylindrical feature from the second initial data frame according to a second predetermined algorithm;
refine the matched at least one of a planar feature and a cylindrical feature from the first initial data frame and the at least one of a planar feature and a cylindrical feature from the second initial data frame by applying a non-linear least squares adjustment according to a third predetermined algorithm; and
output the refined and matched at least one of a planar feature and a cylindrical feature from the first initial data frame and the at least one of a planar feature and a cylindrical feature from the second initial data frame into a combined frame.

7. The system-driven framework of claim 6, wherein the LIDAR mobile mapping system comprises at least one of an unmanned aerial vehicle and a ground-based carrier for acquiring the first and second initial data frames.

8. The system-driven framework of claim 6, wherein the LIDAR mobile mapping system comprises an unmanned aerial vehicle adapted for traveling above a canopy of a forest environment for acquiring the first initial data frame and a ground-based carrier adapted for traveling below the canopy of the forest environment for acquiring the second initial data frame.

9. The system-driven framework of claim 8, wherein the ground-based carrier is a backpack.
